(19) United States
(12) Patent Application Publication
(10) Pub. No.: US 2022/0324511 A1
(43) Pub. Date: Oct. 13, 2022

(54) TAKEOVER DETERMINATION FOR A VEHICLE

(71) Applicant: Ford Global Technologies, LLC, Dearborn, MI (US)

(72) Inventors: Gangarjun Veeramurthy, Sunnyvale, CA (US); Peter W.A. Zegelaar, Heerlen (NL); Tejaswi Koduri, Sunnyvale, CA (US)

(73) Assignee: Ford Global Technologies, LLC, Dearborn, MI (US)

(21) Appl. No.: 17/228,820

(22) Filed: Apr. 13, 2021

(51) Int. Cl. B62D 15/02

(52) U.S. Cl. CPC B62D 15/025; B62D 6/08

(57) ABSTRACT

A computer includes a processor and a memory storing instructions executable by the processor to actuate a steering system of a vehicle to perform a lane-keeping operation, cease the lane-keeping operation upon receiving a takeover request, determine that the takeover request has occurred upon detecting that a torque applied to a steering wheel exceeds a torque threshold, determine that the vehicle is traveling over a road disturbance or will travel over a road disturbance within a time threshold based on receiving map data indicating a location of the road disturbance, and increase the torque threshold upon determining that the vehicle is traveling over the road disturbance or will travel over the road disturbance within the time threshold. The lane-keeping operation includes steering the vehicle without operator input.

### BACKGROUND

Some vehicles are equipped to perform a lane-keeping operation, i.e., steering the vehicle to maintain a lateral position of the vehicle near a center of a lane of travel and/or away from boundaries of the lane. Typically, a computer(s) on board the vehicle uses image data from a forward-facing camera to detect the boundaries of the lane. The computer(s) instructs a steering system of the vehicle to actuate to turn the wheels based on the detected boundaries of the lane. The lane-keeping operation ends upon an operator of the vehicle providing an input that the operator intends to take over.

### BRIEF DESCRIPTION OF THE DRAWINGS

FIG. 1 is a block diagram of an example vehicle.

FIG. 2 is a diagram of a vehicle traveling along a lane of a road.

FIG. 3 is a diagram of an example neural network for determining whether a takeover request has occurred.

FIG. 4 is a process flow diagram of an example process for determining whether a takeover request has occurred.

FIG. 5 is a process flow diagram of an example process for performing and ceasing a lane-keeping operation.

### DETAILED DESCRIPTION

This disclosure provides techniques for distinguishing between a takeover request from an operator to end a lane-keeping operation and an event that mimics the takeover request. When the vehicle is performing a lane-keeping operation, the operator can request to take over control of the steering system by providing a torque input to the steering wheel that is greater than a torque threshold. However, when the vehicle passes over a road disturbance such as a pothole, the steering system can experience what is called bump steer or roll steer, which also causes torque on the steering column, sometimes above the torque threshold. Bump steer occurs when the road wheels turn as a result of passing through the suspension stroke. The system herein increases the torque threshold when the vehicle passes over a road disturbance, as determined by using image data of the road or by using map data indicating a location of the road disturbance. Using map data provides greater reliability than relying solely on image data because the image data can be obscured by rain, fog, etc. or because the road disturbance can sometimes blend into the road. Increasing the torque threshold while passing over road disturbances can minimize false positives from, e.g., bump steer.

A computer includes a processor and a memory storing instructions executable by the processor to actuate a steering system of a vehicle to perform a lane-keeping operation, cease the lane-keeping operation upon receiving a takeover request, determine that the takeover request has occurred upon detecting that a torque applied to a steering wheel exceeds a torque threshold determine that the vehicle is traveling over a road disturbance or will travel over the road disturbance within a time threshold based on receiving map data indicating a location of the road disturbance, and increase the torque threshold upon determining that the vehicle is traveling over the road disturbance or will travel over the road disturbance within the time threshold. The lane-keeping operation includes steering the vehicle without operator input.

The instructions may further include instructions to determine that the vehicle is traveling over the road disturbance or will travel over the road disturbance within the time threshold based on receiving data from a sensor of the vehicle. The sensor may be a camera, and the data from the sensor may be image data of a road over which the vehicle is traveling.

The instructions may further include instructions to receive jerk data from an accelerometer of the vehicle, and determine whether the takeover request has occurred based on the jerk data. The instructions may further include instructions to increase the torque threshold based on the jerk data exceeding a jerk threshold. The instructions may further include instructions to increase the torque threshold upon both the jerk data exceeding the jerk threshold and determining that the vehicle is traveling over the road disturbance or will travel over the road disturbance within the time threshold, and maintain the torque threshold at a same value upon either the jerk data being below the jerk threshold or determining that the vehicle is not traveling over the road disturbance and will not travel over the road disturbance within the time threshold.

The instructions may further include instructions to receive image data of a human operator, and determine that the takeover request has not occurred based on failing to detect eyes of the human operator facing forward in the image data.

The instructions may further include instructions to receive capacitive data from a capacitive sensor on the steering wheel, and determine that the takeover request has not occurred based on the capacitive data indicating that hands of a human operator are not detected. The instructions may further include instructions to receive image data of the human operator, and determine that the takeover request has not occurred based on either the capacitive data indicating that hands of the human operator are not detected or failing to detect eyes of the human operator facing forward in the image data.

Increasing the torque threshold may include increasing the torque threshold from a low torque threshold to a high torque threshold, and the low torque threshold and the high torque threshold may be values of torque stored in the memory.

The instructions may further include instructions to determine that the takeover request has occurred based on a neural network, and inputs to the neural network may include the map data, jerk data from an accelerometer, image data of a human operator, and capacitive data from a capacitive sensor on the steering wheel.

A method includes actuating a steering system of a vehicle to perform a lane-keeping operation, ceasing the lane-keeping operation upon receiving a takeover request, determining that the takeover request has occurred upon detecting that a torque applied to a steering wheel exceeds a torque threshold, determining that the vehicle is traveling over a road disturbance or will travel over the road disturbance within a time threshold based on receiving map data indicating a location of the road disturbance, and increasing the torque threshold upon determining that the vehicle is traveling over the road disturbance or will travel over the road disturbance within the time threshold. The lane-keeping operation includes steering the vehicle without operator input.

The method may further include determining that the vehicle is traveling over the road disturbance or will travel over the road disturbance within the time threshold based on receiving data from a sensor of the vehicle. The sensor may be a camera, and the data from the sensor may be image data of a road over which the vehicle is traveling.

The method may further include receiving jerk data from an accelerometer of the vehicle, and determining whether the takeover request has occurred based on the jerk data. The method may further include increasing the torque threshold based on the jerk data exceeding a jerk threshold. The method may further include increasing the torque threshold upon both the jerk data exceeding the jerk threshold and determining that the vehicle is traveling over the road disturbance or will travel over the road disturbance within the time threshold, and maintaining the torque threshold at a same value upon either the jerk data being below the jerk threshold or determining that the vehicle is not traveling over the road disturbance and will not travel over the road disturbance within the time threshold.

The method may further include receiving image data of a human operator, and determining that the takeover request has not occurred based on failing to detect eyes of the human operator facing forward in the image data.

The method may further include receiving capacitive data from a capacitive sensor on the steering wheel, and determining that the takeover request has not occurred based on the capacitive data indicating that hands of a human operator are not detected.

The method may further include increasing the torque threshold includes increasing the torque threshold from a low torque threshold to a high torque threshold, and the low torque threshold and the high torque threshold are values of torque stored in a memory of a computer.

With reference to the Figures, wherein like numerals indicate like parts throughout the several views, a computer 102 includes a processor and a memory storing instructions executable by the processor to actuate a steering system 104 of a vehicle 100 to perform a lane-keeping operation, cease the lane-keeping operation upon receiving a takeover request, determine that the takeover request has occurred upon detecting that a torque applied to a steering wheel exceeds a torque threshold, determine that the vehicle 100 is traveling over a road disturbance or will travel over the road disturbance within a time threshold based on receiving map data indicating a location of the road disturbance, and increase the torque threshold upon determining that the vehicle 100 is traveling over the road disturbance or will travel over the road disturbance within the time threshold. The lane-keeping operation includes steering the vehicle 100 without operator input.

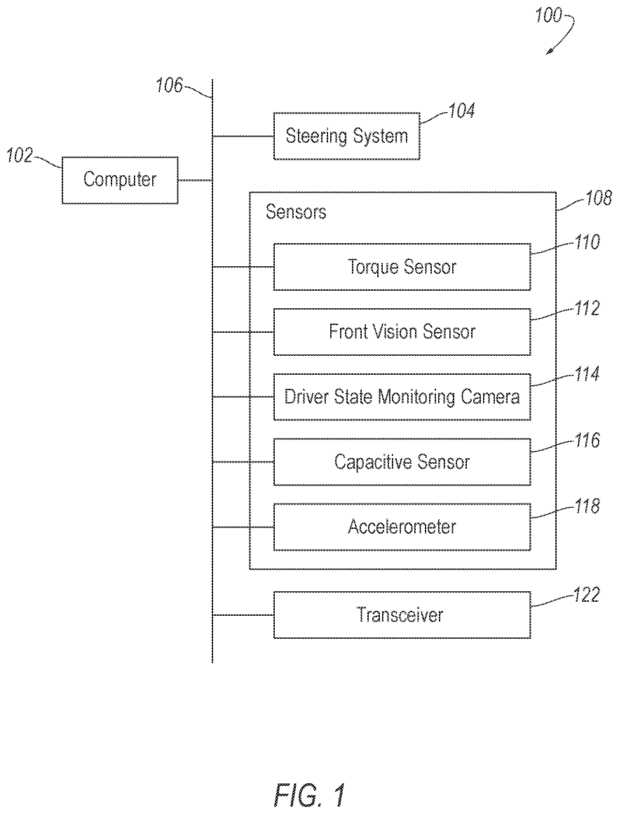

With reference to FIG. 1, the vehicle 100 may be any passenger or commercial automobile such as a car, a truck, a sport utility vehicle, a crossover, a van, a minivan, a taxi, a bus, etc.

The computer 102 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 102 can thus include a processor, a memory, etc. The memory of the computer 102 can include media for storing instructions executable by the processor as well as for electronically storing data and/or databases, and/or the computer 102 can include structures such as the foregoing by which programming is provided. The computer 102 can be multiple computers coupled together.

The computer 102 may transmit and receive data through a communications network 106 such as a controller area network (CAN) bus, Ethernet, WiFi, Local Interconnect Network (LIN), onboard diagnostics connector (OBD-II), and/or by any other wired or wireless communications network. The computer 102 may be communicatively coupled to the steering system 104; sensors 108 including a torque sensor 110, a front vision sensor 112, a driver state monitoring camera 114, a capacitive sensor 116, and an accelerometer 118; a user interface 120; a transceiver 122; and other components via the communications network 106.

The steering system 104 is typically a conventional vehicle steering subsystem and controls the turning of the wheels. The steering system 104 may be a rack-and-pinion system with electric power-assisted steering, a steer-by-wire system, as both are known, or any other suitable system. The steering system 104 can include an electronic control unit (ECU) or the like that is in communication with and receives input from the computer 102 and/or a human operator. The human operator may control the steering system 104 via, e.g., a steering wheel.

The sensors 108 may provide data about operation of the vehicle 100, for example, wheel speed, wheel orientation, and engine and transmission data (e.g., temperature, fuel consumption, etc.). For example, the sensors 108 include the torque sensor 110. The sensors 108 may detect the location and/or orientation of the vehicle 100. For example, the sensors 108 may include global positioning system (GPS) sensors; the accelerometer 118; gyroscopes such as rate, ring laser, or fiber-optic gyroscopes; inertial measurements units (IMU); and magnetometers. The sensors 108 may detect the external world, e.g., objects and/or characteristics of surroundings of the vehicle 100, such as other vehicles, road lane markings, traffic lights and/or signs, pedestrians, etc. For example, the sensors 108 may include radar sensors, scanning laser range finders, light detection and ranging (LIDAR) devices, and image processing sensors such as the front vision sensor 112. The sensors 108 may detect activity or states of occupants in a passenger cabin of the vehicle 100. For example, the sensors 108 may include image sensors such as the driver state monitoring camera 114, occupancy sensors, the capacitive sensor 116, etc.

The torque sensor 110 is a transducer that converts a torsional mechanical input into an electrical output, e.g., a strain gage electrically connected to a Wheatstone bridge circuit. The torque sensor 110 is positioned to detect torque applied to the steering wheel. For example, the torque sensor 110 can be coupled to a steering column of the steering system 104. The torque sensor 110 returns torque data, i.e., in units of force times distance, e.g., Nm, e.g., by returning voltage data convertible to torque data.

The front vision sensor 112 can detect electromagnetic radiation in some range of wavelengths. For example, the front vision sensor 112 may detect visible light, infrared radiation, ultraviolet light, or some range of wavelengths including visible, infrared, and/or ultraviolet light. For another example, the front vision sensor 112 may be a time-of-flight (TOF) cameras, which include a modulated light source for illuminating the environment and detect both reflected light from the modulated light source and ambient light to sense reflectivity amplitudes and distances to the scene. The front vision sensor 112 is positioned to detect a road 126 in front of the vehicle 100, e.g., aimed forward and mounted on a front end of the vehicle 100 or behind a windshield.

The driver state monitoring camera 114 can detect electromagnetic radiation in some range of wavelengths. For example, the driver state monitoring camera 114 may detect visible light, infrared radiation, ultraviolet light, or some range of wavelengths including visible, infrared, and/or ultraviolet light. The driver state monitoring camera 114 is positioned to detect the operator of the vehicle 100, e.g., aimed rearward and mounted on a dash or instrument panel of the vehicle 100.

The front vision sensor 112 and the driver state monitoring camera 114 return image data. The image data are a sequence of image frames of the fields of view of the respective sensors 112, 114. Each image frame is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in an image frame, i.e., position in the field of view of the sensor at the time that the image frame was recorded, can be specified in pixel dimensions or coordinates, e.g., an ordered pair of pixel distances, such as a number of pixels from a top edge and a number of pixels from a left edge of the field of view.

The capacitive sensor 116 is positioned to be touched by a hand of an occupant who is grasping the steering wheel. The capacitive sensor 116 may be any suitable type of sensor that detects changes in an electric field caused by proximity to human skin, e.g., a surface capacitive sensor, a projected capacitive touch sensor such as a mutual capacitive sensor or a self-capacitive sensor, etc. The capacitive sensor 116 returns capacitance data indicating the presence or absence of a hand touching the capacitive sensor 116.

The accelerometer 118 can be any suitable type for detecting a direction and magnitude of acceleration of the vehicle 100, e.g., piezo-electric or microelectromechanical systems (MEMS). The accelerometer 118 returns acceleration data, e.g., three acceleration values along mutually orthogonal axes such as forward, left, and up relative to the vehicle 100. The acceleration values are in units of distance per time squared, e.g., m/s². The accelerometer 118 also thereby returns jerk data. Jerk is the rate of change of acceleration, in units of distance per time cubed, e.g., m/s³.

The user interface 120 presents information to and receives information from the operator of the vehicle 100. The user interface 120 may be located, e.g., on an instrument panel in a passenger cabin of the vehicle 100, or wherever may be readily seen by the operator. The user interface 120 may include dials, digital readouts, screens, speakers, and so on for providing information to the operator, e.g., human-machine interface (HMI) elements such as are known. The user interface 120 may include buttons, knobs, keypads, microphone, and so on for receiving information from the operator.

The transceiver 122 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 122 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), an emergency responder, a mobile device associated with the owner of the vehicle 100, etc. The transceiver 122 may be one device or may include a separate transmitter and receiver.

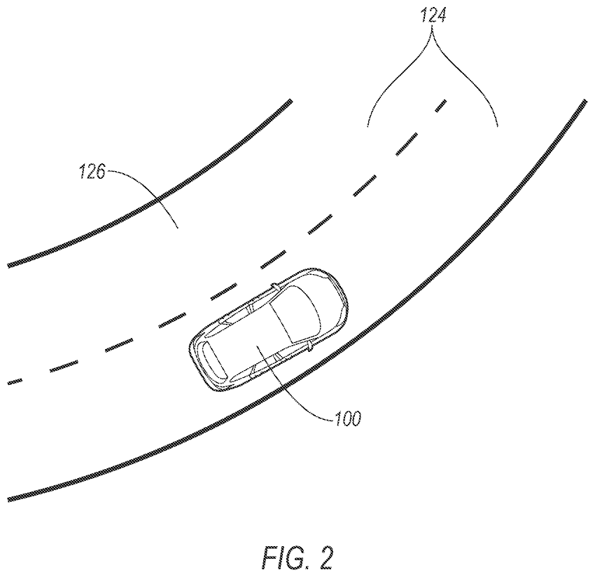

With reference to FIG. 2, the computer 102 can be programmed to perform a lane-keeping operation while traveling along a lane 124 of the road 126. The operator can activate the lane-keeping operation, e.g., via the user interface 120. The lane-keeping operation includes steering the vehicle 100, i.e., actuating the steering system 104, to maintain a lateral position of the vehicle 100 in the lane 124, e.g., at a center line of the lane 124 and/or at least a preset lateral distance away from respective left and right boundaries of the lane 124, without operator input, i.e. without active control by the human operator. The center line is typically an imaginary line in a longitudinal direction of the lane 124 having a same lateral distance to the respective right and left boundaries of the lane 124. For example, the computer 102 can identify the boundaries of the lane 124 using, e.g., an image histogram or image segmentation, as are known, on image data from the front vision sensor 112. The computer 102 can then determine a polynomial equation, e.g., a third-degree polynomial, that predicts points on the center line of the lane 124. The computer 102 can determine a planned curvature for the path followed by the vehicle 100 using the polynomial along with the lateral position and heading of the vehicle 100. The computer 102 can determine a torque for the steering system 104 to apply by minimizing an error between the planned curvature and an actual curvature of the vehicle 100, e.g., by using proportional integral derivative (PID) control. Finally, the computer 102 can instruct the steering system 104 to apply the torque to turn the road wheels.

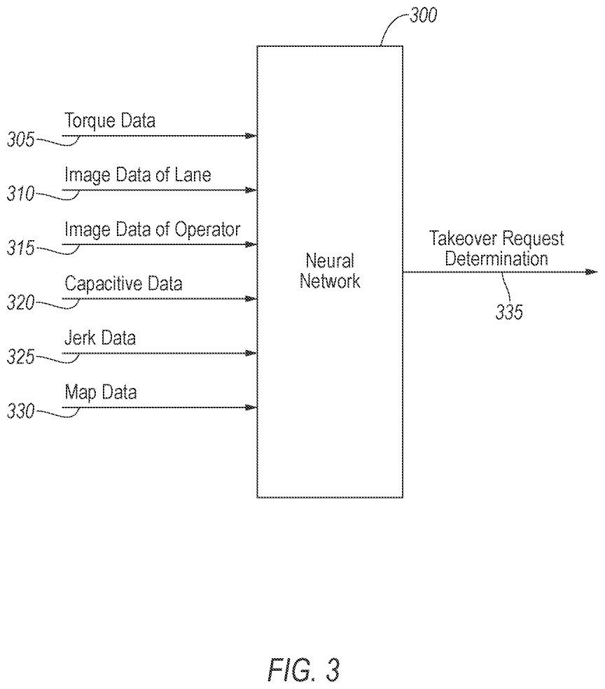

FIG. 3 is a diagram of a neural network 300 for determining whether a takeover request has occurred. The memory of the computer 102 stores executable instructions for running the neural network 300 and/or programming can be implemented in structures such as mentioned above. As a general overview, the neural network 300 receives as inputs the torque data 305 from the torque sensor 110, the image data 310 from the front vision sensor 112, the image data 315 from the driver state monitoring camera 114, the capacitive data 320 from the capacitive sensor 116, the jerk data 325 from the accelerometer 118, and map data 330. The data is further processed as described below. The neural network 300 outputs a binary determination 335 of whether the operator has requested a takeover, i.e., that the lane-keeping operation cease and manual control of the steering system 104 by the operator resume. The neural network 300 makes the determination based on the inputs.

The torque data 305 is converted to units of torque, e.g., N·m (Newton-meters), before being inputted to the neural network.

The image data 310 from the front vision sensor 112 is processed to determine whether the image data indicates a road disturbance, and if so, a type and/or dimensions. The type of the road disturbance is a classification of the road disturbance, e.g., pothole, speed bump, rumble strips, gravel-road undulations, etc. The dimensions of the road disturbance can include height/depth relative to a surface of the road 126, length along a longitudinal direction relative to the vehicle 100, width along a lateral direction relative to the vehicle 100, area of the road surface, etc.

The computer 102 can determine the type of the road disturbance using conventional image-recognition techniques, e.g., a convolutional neural network programmed to accept images as input and output an identified type of road disturbance, with one type being “none.” A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type, and the final output is the type with the highest score, e.g., pothole, speed bump, rumble strips, gravel-road undulations, none, etc. A road disturbance is absent if the type is “none” and present if the type is any other type.

The computer 102 can determine the dimensions by converting positions in the image frame, given in pixel coordinates, to positions in the external environment relative to the vehicle 100, according to a mapping stored in memory for converting from pixel coordinates to position coordinates. The computer 102 can then apply known geometric relations to the position coordinates to determine the dimensions.

The image data 315 from the driver state monitoring camera 114 can be processed to determine an attentiveness score for the operator. The computer 102 can detect features of the head and face of the operator in the image data 315, e.g., by using any suitable facial-detection technique, e.g., knowledge-based techniques such as a multiresolution rule-based method; feature-invariant techniques such as grouping of edges, space gray-level dependence matrix, or mixture of Gaussian; template-matching techniques such as shape template or active shape model; or appearance-based techniques such as eigenface decomposition and clustering, Gaussian distribution and multilayer perceptron, neural network, support vector machine with polynomial kernel, a naive Bayes classifier with joint statistics of local appearance and position, higher order statistics with hidden Markov model, or Kullback relative information. Then the computer 102 can use outputs produced as a byproduct of the facial detection that indicate features such as an orientation of the head, a gaze direction of the eyes, etc. The attentiveness score can be calculated from the features, e.g., by coding different features based on how much they indicate attentiveness and summing the coding of the different features, e.g., how close to straight forward is head orientation, how close to straight forward is eye gaze, how open are the eyes, etc. The score can then be normalized to a scale of, e.g., 0 to 100.

The capacitive data 320 can be processed to generate a score of how much of the operator's hands are on the steering wheel, e.g., from 0% to 100%. The capacitive data 320 can indicate a surface area of the steering wheel being contacted by the operator's hands, and that area can be divided by a prestored area. The prestored area can be chosen as a typical surface area of the steering wheel covered when two hands firmly grip the steering wheel.

The acceleration data from the accelerometer 118 can be converted to the jerk data 325 by tracking the change in acceleration over each time step divided by the duration of a time step.

The map data 330 can be stored in the memory of the computer 102. The map data 330 can be regularly updated with new map data received via the transceiver 122. The map data can include the locations and dimensions of the lanes 124 of the roads 126 in an area through which the vehicle 100 is traveling. The map data can include locations of road disturbances. For example, the map data can include crowdsourced data about road disturbances. The map data can include, e.g., a number of other vehicles that have reported a road disturbance at a location, times at which the other vehicles reported the road disturbance, etc.

The neural network 300 can be generated by training with training data. The training data can be created by gathering the data described above while test-driving vehicles as the vehicles travel over various known road disturbances and as the test operators input takeover requests. The training data thus includes whether the operator in fact requested a takeover.

The neural network 300 can be any suitable type of neural network, e.g., a convolutional neural network. A convolutional neural network includes a series of layers, with each layer using the previous layer as input. A base layer receives the data described above as input. Each further layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates scores for takeover request and for nontakeover request, and the final determination 335 is whichever of takeover request and nontakeover request has the highest score.

Changes in each type of data supplied as input either increases or decreases a likelihood of the neural network 300 determining that a takeover request has occurred. Higher torque data 305 increases the likelihood of the neural network 300 determining that a takeover request has occurred. For example, the neural network 300 can determine that a takeover request has occurred in response to the torque data 305 exceeding a torque threshold. The torque threshold is determined in the process of training the neural network 300 described above. The torque threshold is affected by the other data inputted to the neural network 300 in a manner determined by the training, meaning that a value of the torque threshold can vary. Higher torque data 305 increases a likelihood that the torque data 305 is above a current value of the torque threshold.

The image data 310 from the front vision sensor 112 indicating that the type of road disturbance is not none and/or indicating greater dimensions of the road disturbance decreases the likelihood of the neural network 300 determining that a takeover request has occurred, e.g., by increasing the torque threshold.

A higher attentiveness score increases the likelihood of the neural network 300 determining that a takeover request has occurred, e.g., by decreasing the torque threshold. In other words, greater attentiveness by the operator makes the neural network 300 more confident that a given torque represents a takeover request. For example, detecting the eyes of the operator in the image data 315 can increase the attentiveness score and thereby decrease the torque threshold, e.g., by preventing other inputs from increasing the torque threshold by as much. Likewise, failing to detect the eyes of the operator in the image data 315 can decrease the attentiveness score and thereby increase the torque threshold.

A higher score for the capacitive data 320 increases the likelihood of the neural network 300 determining that a takeover request has occurred, e.g., by decreasing the torque threshold. In other words, a more complete grip of the steering wheel by the operator makes the neural network 300 more confident that a given torque represents a takeover request.

Higher jerk data 325 decreases the likelihood of the neural network 300 determining that a takeover request has occurred, e.g., by increasing the torque threshold. Higher jerk data represents a greater likelihood of traveling over a road disturbance, which makes the neural network 300 less confident that a given torque represents a takeover request.

The map data 330 indicating a road disturbance within a time threshold decreases the likelihood of the neural network 300 determining that a takeover request has occurred, e.g., by increasing the torque threshold. The time threshold can be chosen to encompass a typical length of time for the operator to request the takeover. The map data indicating a greater number of reports of the road disturbance or a shorter time since a last report of the road disturbance decreases the likelihood of the neural network 300 determining that a takeover request has occurred, e.g., by increasing the torque threshold.

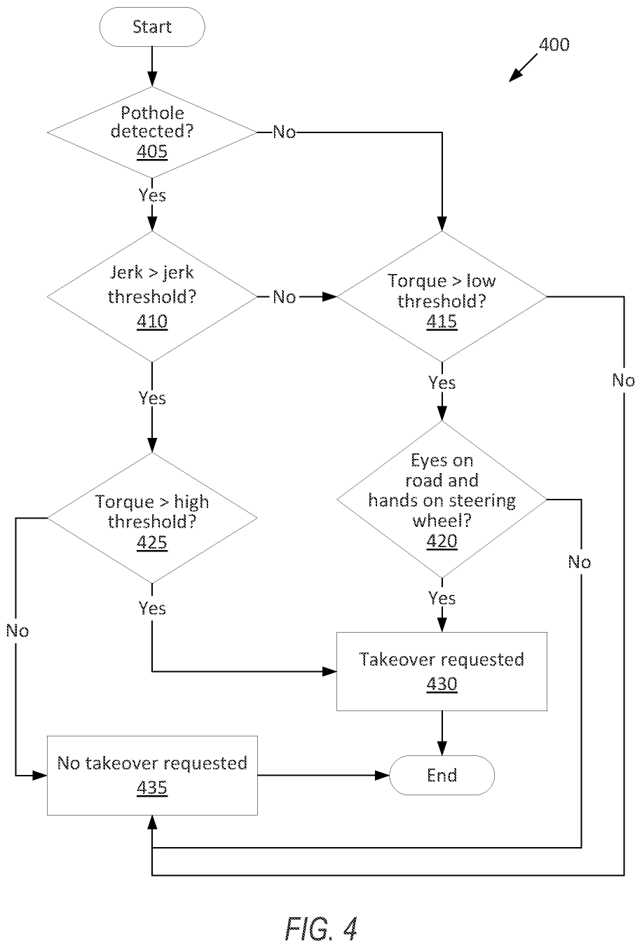

FIG. 4 is a process flow diagram illustrating an exemplary process 400 for determining whether a takeover request has occurred. The memory of the computer 102 stores executable instructions for performing the steps of the process 400 and/or programming can be implemented in structures such as mentioned above. The process 400 is an alternative to the neural network 300 and can be stored in the computer 102 instead of the neural network 300. A manufacturer of the vehicle 100 can choose which of the neural network 300 and the process 400 to install based on computational efficiency and accuracy. Alternatively, the computer 102 can store both the process 400 and the neural network 300 while performing the training of the neural network 300, and the computer 102 can use the process 400 until the neural network 300 is sufficiently trained and then switch to using the neural network 300.

As a general overview of the process 400, the computer 102 determines that a takeover request has occurred when the vehicle 100 is traveling or will travel over a road disturbance, a jerk is above a jerk threshold, and a torque on the steering wheel exceeds an increased torque threshold, i.e., a high torque threshold stored in memory. If the vehicle 100 is not traveling and is not predicted to travel over a road disturbance, or if the jerk is below the jerk threshold, the computer 102 determines that a takeover request has occurred when the torque exceeds a baseline torque threshold, i.e., a low torque threshold stored in memory, and the operator has their eyes toward the road 126 and their hands on the steering wheel. Otherwise, the computer 102 determines that a takeover request has not occurred.

The process 400 begins in a decision block 405, in which the computer 102 determines whether the vehicle 100 is traveling over a road disturbance or will travel over a road disturbance within a time threshold. The time threshold can be chosen to encompass a typical length of time for the operator to request the takeover. The computer 102 can determine that the vehicle 100 is traveling over a road disturbance or will travel over a road disturbance within the time threshold based on the image data from the front vision sensor 112 or based on the map data. The computer 102 can use conventional image-recognition techniques on the image data, e.g., a convolutional neural network programmed to accept images as input and output an identified type of road disturbance, with one type being “none,” as described above with respect to the image data 310 in the neural network 300. Alternatively or additionally, the computer 102 can use the map data. For example, the map data can indicate the location of the road disturbance, and the computer 102 can determine that the vehicle 100 will travel over the road disturbance if the location is less than a distance ahead of the vehicle 100. The distance can be the time threshold multiplied by a current speed of the vehicle 100. Upon determining that the vehicle 100 is traveling over a road disturbance or will travel over a road disturbance within the time threshold based on either the image data or the map data, the process 400 proceeds to a decision block 410. Upon determining that the vehicle 100 is not traveling over the road disturbance and will not travel over the road disturbance within the time threshold, the process 400 proceeds to a decision block 415.

In the decision block 410, the computer 102 determines whether the jerk data exceeds a jerk threshold. The jerk threshold can be chosen as a lower end of a range of typical jerks produced when the vehicle 100 travels over a road disturbance, which can be determined by empirical testing and data-gathering. Upon the jerk data exceeding the jerk threshold, the process 400 proceeds to a decision block 425. Upon the jerk data being below the jerk threshold, the process 400 proceeds to the decision block 415.

In the decision block 415, the computer 102 determines whether the torque applied to the steering wheel exceeds a baseline torque threshold. The baseline torque threshold is a value of torque stored in the memory of the computer 102. The baseline torque threshold is chosen to be higher than torques caused by inadvertent touches of the steering wheel by the operator and lower than torques caused by the operator intentionally rotating the steering wheel. The baseline torque threshold is the torque threshold used when the vehicle 100 is not passing over road disturbances. In other words, the computer 102 maintains the torque threshold at a same value, i.e., a baseline value. Upon the torque exceeding the baseline torque threshold, the process 400 proceeds to a decision block 420. Upon the torque being below the baseline torque threshold, the process 400 proceeds to a block 435.

In the decision block 420, the computer 102 whether the eyes of the operator are facing forward and the hands of the operator are on the steering wheel. The computer 102 determines whether the eyes of the operator are facing forward based on the image data from the driver state monitoring camera 114. The computer 102 can detect a gaze direction of the operator in the image data, e.g., by using any suitable facial-detection technique, e.g., knowledge-based techniques such as a multiresolution rule-based method; feature-invariant techniques such as grouping of edges, space gray-level dependence matrix, or mixture of Gaussian; template-matching techniques such as shape template or active shape model; or appearance-based techniques such as eigenface decomposition and clustering, Gaussian distribution and multilayer perceptron, neural network, support vector machine with polynomial kernel, a naive Bayes classifier with joint statistics of local appearance and position, higher order statistics with hidden Markov model, or Kullback relative information. Then the computer 102 can use outputs produced as a byproduct of the facial detection that indicate the gaze direction of the eyes. The computer 102 determines whether the hands of the operator are on the steering wheel based on the capacitive data, e.g., based on whether the capacitive data detects the hands. If the eyes of the operator are facing forward and the hands of the operator are on the steering wheel, the process 400 proceeds to a block 430. If the computer 102 either fails to detect the eyes of the operator facing forward or fails to detect the hands of the operator on the steering wheel, the process 400 proceeds to the block 430.

In the decision block 425, the computer 102 determines whether the torque applied to the steering wheel exceeds an increased torque threshold. The increased torque threshold is a value of torque stored in the memory of the computer 102. The increased torque threshold is chosen to be higher than torques caused by traveling over typical road disturbances. The increased torque threshold is the torque threshold used when the vehicle 100 is passing over road disturbances. In other words, the computer 102 increases the torque threshold from the baseline torque threshold to the increased torque threshold, i.e., from a low torque threshold to a high torque threshold. Upon the torque exceeding the increased torque threshold, the process 400 proceeds to the block 430. Upon the torque being below the baseline torque threshold, the process 400 proceeds to the block 435.

In the block 430, the computer 102 makes the determination that a takeover request has occurred, i.e., confirms the takeover request. After the block 430, the process 400 ends.

In the block 435, the computer 102 makes the determination that a takeover request has not occurred, i.e., fails to confirm the takeover request. After the block 435, the process 400 ends.

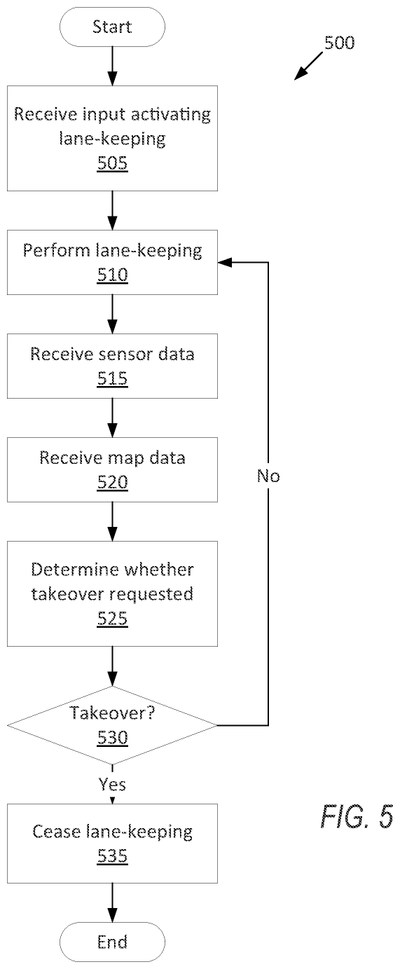

FIG. 5 is a process flow diagram illustrating an exemplary process 500 for performing and ceasing a lane-keeping operation. The memory of the computer 102 stores executable instructions for performing the steps of the process 500 and/or programming can be implemented in structures such as mentioned above. As a general overview of the process 500, the computer 102 receives an input activating the lane-keeping operation and begins performing the lane-keeping operation. The computer 102 receives the data from the sensors 108 and the map data. The computer 102 uses that data to determine whether a takeover request has occurred, e.g., using the neural network 300 or the process 400 described above. The computer 102 continues performing the lane-keeping operation until the computer 102 determines that a takeover request has been received. Upon receiving the takeover request, the computer 102 ceases the lane-keeping operation.

The process 500 begins in a block 505, in which the computer 102 receives an input to the user interface 120 to activate the lane-keeping operation.

Next, in a block 510, the actuates the steering system 104 to perform the lane-keeping operation as described above.

Next, in a block 515, the computer 102 receives data from the sensors 108, including the torque data from the torque sensor 110, the image data from the front vision sensor 112, the image data from the driver state monitoring camera 114, the capacitive data from the capacitive sensor 116, and the jerk data from the accelerometer 118.

Next, in a block 520, the computer 102 receives the map data, e.g., from memory and/or updates to the map data via the transceiver 122.

Next, in a block 525, the computer 102 determines whether a takeover request has been received. The computer 102 can run the neural network 300 or perform the process 400, depending on which has been stored in the memory of the computer 102.

Next, in a decision block 530, the computer 102 determines a result from the block 525. Upon receiving a takeover request from the operator as determined in the block 525, the process 500 proceeds to a block 535. Upon failing to receive a takeover request from the operator as determined in the block 525, the process 500 returns to the block 510 to continue performing the lane-keeping operation.

In the block 535, the computer 102 ceases the lane-keeping operation. The computer 102 may instruct the user interface 120 to provide a notification to the operator that the lane-keeping operation is ceasing. The steering system 104 begins to respond to steering-wheel inputs from the operator. After the block 535, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory storing instructions executable by the processor to:
actuate a steering system of a vehicle to perform a lane-keeping operation, wherein the lane-keeping operation includes steering the vehicle without operator input;
cease the lane-keeping operation upon receiving a takeover request;
determine that the takeover request has occurred upon detecting that a torque applied to a steering wheel exceeds a torque threshold;
determine that the vehicle is traveling over a road disturbance or will travel over the road disturbance within a time threshold based on receiving map data indicating a location of the road disturbance; and
increase the torque threshold upon determining that the vehicle is traveling over the road disturbance or will travel over the road disturbance within the time threshold.

2. The computer of claim 1, wherein the instructions further include instructions to determine that the vehicle is traveling over the road disturbance or will travel over the road disturbance within the time threshold based on receiving data from a sensor of the vehicle.

3. The computer of claim 2, wherein the sensor is a camera, and the data from the sensor is image data of a road over which the vehicle is traveling.

4. The computer of claim 1, wherein the instructions further include instructions to receive jerk data from an accelerometer of the vehicle, and determine whether the takeover request has occurred based on the jerk data.

5. The computer of claim 4, wherein the instructions further include instructions to increase the torque threshold based on the jerk data exceeding a jerk threshold.

6. The computer of claim 5, wherein the instructions further include instructions to increase the torque threshold upon both the jerk data exceeding the jerk threshold and determining that the vehicle is traveling over the road disturbance or will travel over the road disturbance within the time threshold, and maintain the torque threshold at a same value upon either the jerk data being below the jerk threshold or determining that the vehicle is not traveling over the road disturbance and will not travel over the road disturbance within the time threshold.

7. The computer of claim 1, wherein the instructions further include instructions to receive image data of a human operator, and determine that the takeover request has not occurred based on failing to detect eyes of the human operator facing forward in the image data.

8. The computer of claim 1, wherein the instructions further include instructions to receive capacitive data from a capacitive sensor on the steering wheel, and determine that the takeover request has not occurred based on the capacitive data indicating that hands of a human operator are not detected.

9. The computer of claim 8, wherein the instructions further include instructions to receive image data of the human operator, and determine that the takeover request has not occurred based on either the capacitive data indicating that hands of the human operator are not detected or failing to detect eyes of the human operator facing forward in the image data.

10. The computer of claim 1, wherein increasing the torque threshold includes increasing the torque threshold from a low torque threshold to a high torque threshold, and the low torque threshold and the high torque threshold are values of torque stored in the memory.

11. The computer of claim 1, wherein the instructions further include instructions to determine that the takeover request has occurred based on a neural network, and inputs to the neural network include the map data, jerk data from an accelerometer, image data of a human operator, and capacitive data from a capacitive sensor on the steering wheel.

12. A method comprising:
actuating a steering system of a vehicle to perform a lane-keeping operation, wherein the lane-keeping operation includes steering the vehicle without operator input;
ceasing the lane-keeping operation upon receiving a takeover request;
determining that the takeover request has occurred upon detecting that a torque applied to a steering wheel exceeds a torque threshold;
determining that the vehicle is traveling over a road disturbance or will travel over the road disturbance within a time threshold based on receiving map data indicating a location of the road disturbance; and
increasing the torque threshold upon determining that the vehicle is traveling over the road disturbance or will travel over the road disturbance within the time threshold.

13. The method of claim 12, further comprising determining that the vehicle is traveling over the road disturbance or will travel over the road disturbance within the time threshold based on receiving data from a sensor of the vehicle.

14. The method of claim 13, wherein the sensor is a camera, and the data from the sensor is image data of a road over which the vehicle is traveling.

15. The method of claim 12, further comprising receiving jerk data from an accelerometer of the vehicle, and determining whether the takeover request has occurred based on the jerk data.

16. The method of claim 15, further comprising increasing the torque threshold based on the jerk data exceeding a jerk threshold.

17. The method of claim 16, further comprising increasing the torque threshold upon both the jerk data exceeding the jerk threshold and determining that the vehicle is traveling over the road disturbance or will travel over the road disturbance within the time threshold, and maintaining the torque threshold at a same value upon either the jerk data being below the jerk threshold or determining that the vehicle is not traveling over the road disturbance and will not travel over the road disturbance within the time threshold.

18. The method of claim 12, further comprising receiving image data of a human operator, and determining that the takeover request has not occurred based on failing to detect eyes of the human operator facing forward in the image data.

19. The method of claim 12, further comprising receiving capacitive data from a capacitive sensor on the steering wheel, and determining that the takeover request has not occurred based on the capacitive data indicating that hands of a human operator are not detected.

20. The method of claim 12, wherein increasing the torque threshold includes increasing the torque threshold from a low torque threshold to a high torque threshold, and the low torque threshold and the high torque threshold are values of torque stored in a memory of a computer.
